(19) United States
(12) Patent Application Publication
(10) Pub. No.: US 2008/0012159 A1
(43) Pub. Date: Jan. 17, 2008

(54) Device For Spraying Fluids

(75) Inventors: Hellmut Schmid, Sachsenheim (DE); Ullrich Kraatz, Leonberg (DE); Thomas Brinz, Bissingen A. D. Teck (DE); Herbert Gruhn, Ludwigsburg (DE); Markus Tiefenbacher, Fellbach-Schmiden (DE); Thomas Geiger, Walddorfhaeslach (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/587,107

(22) PCT Filed: Feb. 15, 2005
(86) PCT No.: PCT/EP05/50647

§ 371 Date: Oct. 19, 2006

(30) Foreign Application Priority Data
Apr. 22, 2004 (DE) 10 2004 020 205.2

(51) Int. Cl. B05B 7/24

(52) U.S. Cl. 261/73; 239/96

(57) ABSTRACT

A device is provided for spraying flowable spray fluids (6) having at least one fluid reservoir (1) that includes at least one partition (2, 4), for storing the spray fluid (6), a spray opening (8) being provided for the outflow of the spray fluid (6) from the device, and a corresponding fluid reservoir (1); a change of the spray fluid (6) being made easier. According to the present invention, this is achieved by having a partition of the fluid reservoir (1) include at least one adjustable partition region (2) for changing the reservoir volume of the fluid reservoir (1).

The present invention relates to a fluid reservoir or a device for spraying flowable spray fluids having at least one fluid reservoir that includes at least one partition for storing the spray fluid, according to the definition of the species in Claim 1 or 11.

### BACKGROUND INFORMATION

In almost all areas of the development of paint (and/or lacquers and varnishes) and the processing of paints, spraying methods are used to apply the paints. In this connection, the most varied types of gun spraying methods have been usual in the trade for a long time, such as pneumatic (nozzle) atomization, airless atomization, combination atomization, high rotational atomization or flow cup supply, suction cup supply, pressure pot supply or metering pump supply. In some methods, the purely kinematic paint transmission onto the surface to be painted may be supported by electrostatic charging of the paint.

In these methods, so-called spray guns, or the like, are generally used. Appropriate spray guns include especially a connecting possibility for the external paint supply (e.g. pressure pot) or a supply container for the spray fluid or the paint to be processed, one or more nozzles, as well as frequently also a connecting channel between a paint connecting facility or a supply container and nozzle, as well as a metering valve. A supply container for spray guns is known, for instance, from DE 22 46 165 A1, which is developed as a paint tin sold in the trade.

In all the known methods it is a disadvantage that the paint supply or the paint guide inside the gun is rather complex, and because of this, rapid color changes, and, if possible, automatic ones, are critical and/or costly. As a rule, for the color change, certain components, such as the material nozzle, have to be removed and/or cleaned. Systems that manage to do this automatically are very complex and require, in general, large quantities of solvents for flushing out the equipment, which is customary in automobile body painting. In addition, such systems are frequently suitable only for certain painting systems, that were previously specified, within narrow boundaries.

Objective and Advantages of the Present Invention

With respect to this, it is the object of the present invention to propose a device for spraying flowable spray fluids, having at least one fluid reservoir that includes at least one partition, a spray opening for the outflow of the spray fluid from the device being provided, or to prepare an appropriate fluid reservoir, whereby a change in the spray fluid is made easier.

Starting from a device or a fluid reservoir of the type indicated in the introduction, this objective is achieved by the characterizing features of Claims 1 and 11.

The measures indicated in the dependent claims make possible advantageous embodiments and further developments of the present invention.

Accordingly, a device and a fluid reservoir according to the present invention are distinguished by the partition of the fluid reservoir including at least one adjustable partition region for changing the storage volume of the fluid reservoir.

With the aid of such an adjustable or movable partition region, in general, because of the change especially by a lessening of, or the reduction in the reservoir volume, a change is also achieved, especially a lessening of, or a reduction in the area of the fluid reservoir touched by the spray fluid. Because of this diminution of the volume or the area that can store the fluid, or which is in contact with the stored spray fluid and is consequently contaminated by it, the remaining quantity of the spray fluid can be lessened. Because of this, for example, the cleaning effort in response to a change in the spray fluid, especially of the color, can be minimized.

In addition, less solvent is also required for the cleaning to remove the smaller quantity of spray fluid. According to the present invention, one may consequently achieve protection of the resources and a reduction in stresses on the environment by remnants and substances for cleaning materials and consumables.

In one conceivable variant of the present invention, the adjustable partition region may be developed as an elastic or flexible and/or deformable partition region. For instance, an elastomer or a rubber substance or the like can be used for this partition region. For instance, an elastomer or a rubber substance or the like can be used for this partition region.

In one preferred specific embodiment of the present invention, the partition region is developed as a piston, the piston being able to be guided at other partition regions of the fluid reservoir. This makes it possible that an advantageously mechanically stable fluid reservoir, having the change in reservoir volume according to the present invention, is able to be implemented. In a mechanically stable fluid reservoir it is, for instance, of advantage if it is able to be particularly easily handled, stored, transported and applied.

Furthermore, in this specific embodiment according to the present invention, one may revert to piston-cylinder systems which are already available in the trade for different cases of application. In particular, in the case of relatively small volumes of ca. 2 to 50 cm³, as are usual, for instance, in laboratory or experimental applications, among other things, in paint development or paint processing such as in model construction or the like, especially sprays available in the trade may be used as fluid reservoirs according to the present invention. This makes it possible to achieve an economically favorable implementation of the present invention.

Advantageously, the piston has a stripping function or a stripping element, so that the other partition regions of the fluid reservoir are advantageously freed from and cleaned of spray fluid or paint by the adjustment of the piston. By doing this, the cleaning of at least a part of the fluid reservoir is achieved by simply the adjustment of the piston. The piston is advantageously connected by form (positive) locking to the greatest extent possible, to the floor or base of the fluid reservoir, so that in the emptied position of the piston the reservoir volume of the fluid reservoir is able to be minimized to the greatest extent possible. This makes possible an especially clear reduction in the residual quantities of the spray fluid, so that cleaning of the reservoir and a color change or the like is simplified in an advantageous manner.

Advantageously, a metering unit is provided for metering the quantity of spray fluid flowing out through the spray opening. Because of this, above all the uniform, finely divided application of the spray fluid or paint onto appropriate surfaces is improved.

The metering unit preferably includes at least one drive unit, for adjusting the partition region, that is particularly able to be regulated or controlled. Using this measure, above all the processing and the application of the spray fluid becomes advantageously able to be automated. Just because of a regulatable or controllable drive unit of the metering unit, the outflowing quantity of the spray fluid from the device according to the present invention is able to be set particularly exactly. This is able to improve both the quality and the reproducibility of making the application. The corresponding is of particular advantage, on the one hand, in the case of automated gun spraying^{S}, and for the development of appropriate spray fluids or paints or the like.

In one advantageous variant of the present invention, the drive unit is designed as a linear drive. Such a drive unit developed as a linear drive is of particular advantage especially in combination with a piston. The generally linear motion of the piston corresponds to the linear drive, so that an especially exact metering is possible in response to a constructively advantageous implementation of the drive.

The linear drive may include, for example, a lifting cylinder or the like. The drive unit preferably includes at least one drive spindle. By an advantageous adaptation, for instance, of the gears and/or the slope of the spindle and/or the rotational speed of the spindle to the respective application, an advantageous adaptation of the metering quantity to the properties of the spray fluid or the paint is able to be achieved.

In a special further refinement of the present invention, an atomizer for atomizing the spray fluid is provided. With the aid of this measure, an especially advantageous distribution of the spray fluid is achieved, whereby an especially high quality of the application procedure is ensured. A fluid fog, or the like, is generated, for instance, made up of the tiniest fluid droplets. Advantageously, the atomization takes place with the cooperation of a nozzle and an atomization gas. Furthermore, the metering unit is able to include the atomizer, in an advantageous manner. In this connection, the metering is able to be controlled and/or improved in certain specific embodiments.

Depending on the specific case of application, the atomization of the spray fluid is able to be implemented with or without atomization fluid. For the atomizer, one may fall back upon devices already being sold in the trade and corresponding methods, so that an economically particularly favorable implementation of the present invention is achievable. Preferably, compressed air is provided as atomization fluid.

In one advantageous variant of the present invention, the atomizer or one or more atomization openings/atomization nozzles are situated at least partially concentrically about the spray opening/spray nozzle. Corresponding systems have proven themselves in practice.

Advantageously, the fluid reservoir is developed as a one-way fluid reservoir. Using this measure, the handling expenditure or cleaning expenditure is especially minimal when there is a change in the spray fluid or the color. If appropriate, the solely one-way components or no further components that come into contact with the spray fluid are provided, so that when there is a corresponding change in the spray fluid, the cleaning of a device according to the present invention can be done totally without.

For instance, when there is a change in the spray fluid, the fluid reservoir having the first spray fluid can be replaced by a second fluid reservoir having a second spray fluid, without, for instance, cleaning of the device or further components being necessary. During the use of the second fluid reservoir, for instance, the first fluid reservoir is able to be cleaned in an advantageous manner and, if necessary, to be filled again with a further, especially third spray fluid.

Besides for paint applications, the device or the fluid reservoir according to the present invention can generally also be used in an advantageous manner for other coating applications or surfacing applications, using the most different fluids.

### DESCRIPTION OF THE EXEMPLARY EMBODIMENT

An exemplary embodiment of the present invention is shown in the drawing and is elucidated in greater detail in the following text with reference to the single figure.

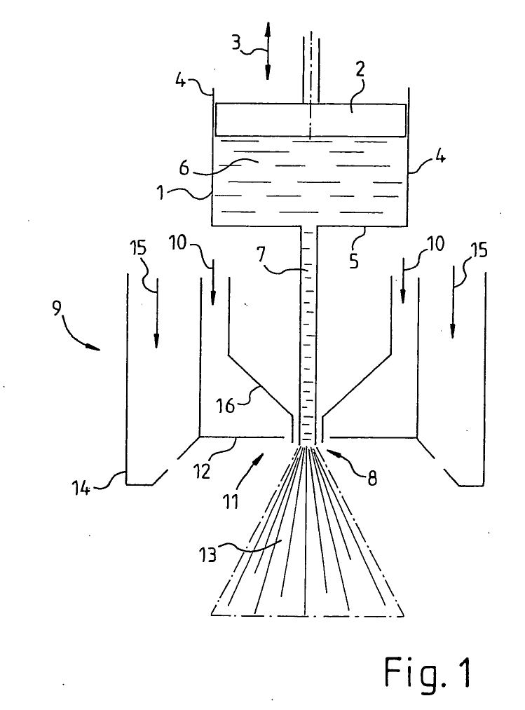

FIG. 1 schematically shows a section of a spray device having a fluid reservoir 1 according to the present invention. Reservoir 1 is, for instance, filled with paint 6, and has a piston 2, which is adjustable along a direction 3. Piston 2 is guided on sidewalls 4 during its adjustment. In one final position of piston 2 it is situated at a base 5, or at a floor 5 of reservoir 1. In an advantageous manner, piston 2 is developed in form locking with base 5 and as stripper 2 of sidewalls 4, so that a nearly complete emptying of reservoir 1 is achieved.

In the variant of the present invention shown, a line 7 or a canula 7 is provided which connects reservoir 1 to a spray opening 8. According to the variant shown, canula 7 includes opening 8. This makes it possible that only reservoir 1 and its canula 7 is able to come into contact with paint 6, so that by replacing these two components 7, 1, a simple exchange of paint 6 is able to be implemented.

If necessary, reservoir 1 and canula 7, emptied to the greatest extent possible, is able to be cleaned after removal of paint 6 and provided for further use and for filling with new paint 6. Alternatively to this, both components 1, 7 can be developed as one-way components 1, 7, which are disposed of after being removed.

For the adjustment of piston 2 along direction 3, that is, both in the direction towards base 5 and also in the opposite direction, a motor drive may be used, among other things. An appropriate motor, in particular a servomotor or the like, which converts the adjustment of piston 2 using a drive spindle, is not shown in greater detail, only for reasons of clarity. For these components, one may fall back on components that are already customary in the trade, which makes possible an economical application of the present invention.

In addition, in special application cases, an atomizer 9 can be used for the improvement of the gun spraying^{S} of paint 6. For the atomization, atomization air 10 is supplied to a spray head 11, so that it flows out from an air cap 12 in such a way that metered-in paint 6 flows out in an advantageous way as spray cone 13 from the device according to the present invention.

Atomizer 9 is designed in an advantageous manner in such a way that air 10 is supplied to spray head 11 or can flow out of it, at least on two opposite sides of canula 7 and/or concentric with it.

In addition, a so-called horn nozzle 14 can optionally be provided, to which so-called horn air 15 is supplied, which flows out of horn nozzle 14 in such a way that, for certain applications, an especially advantageous spray cone 13 is implementable.

In the exemplary embodiment according FIG. 1 shown, reservoir 1 is built into a spray gun that is available in the trade, so that a device according to the present invention is implemented in an elegant manner. Because of this, a paint nozzle 16 is shown in FIG. 1 that, according to the present invention, is generally no longer needed, which, however, can still be used for the accurate, concentric positioning of canula 7 and for the problem-free introduction of the latter into the atomization unit.

Furthermore, it becomes clear in FIG. 1 that, according to the present invention, a nozzle needle, which is generally customary in the related art, is no longer required. Accordingly, one may call a device according to the present invention a valveless device.

For instance, in paint development, in model building or the like, in which comparatively small volumes have to be sprayed, typically between approximately 2 to 50 cm³, reservoir 1 and canula 7 are able to be designed as a one-way metering spray gun 1, 7 that is customary in the trade. In general, the present invention, besides being used in the above-mentioned application fields, may also be used in additional ones, such as in the electric tool field, among other things, in drilling machines, screwdrivers, etc., with or without accumulators, as well as for home and trade applications.

The added paint raw material components are able to be homogenized before being metered, in reservoir 1 having canula 7 or metering needle 7. For this, different methods customary in the trade, such as stirring, shaking or using a dissolver, etc., may be used. The processing of ready formulations using a device according to the present invention is also possible. After homogenization, degassing of the mixture takes place. Thereafter, a metering piston 2 is applied. The complete unit 1, 7 is set into spray gun or spray head 11 which, in principle, may be made up of the head components of a spray gun or the like, that are customary in the trade. This means that material nozzle 16, atomizer air cap 12, with or without horn air nozzle 14, and corresponding air supply are able to be designed as components customary in the trade. The spray gun is able to be adapted to the material to be processed over wide limits, above all by the selection of metering spray gun 1, metering needle 7, and/or air cap 12.

The spraying process is triggered by the operation of the metering piston 2, for instance, via a servomotor, in response to the connection of atomization air 10. The atomization procedure or the spraying procedure is ended by cutting off spraying air 10 and stopping metering piston 2. In order to avoid possible subsequent dripping, metering piston 2 is able to be moved backwards (in a very small measure) after the stop.

After finishing the application, the complete spray metering unit 1, 7 can be removed manually and/or automatically without any contamination of the environment, as well as, for instance, kept as a retained sample, especially sealed airtight, or disposed of.

In general, it is of particular advantage in the present invention that the functional components are reduced, and thereby the components 1, 7 coming into contact with paint 6 are lessened to a minimum. This makes possible implementing particularly small batches of paint. By the use of one-way components 1, 7 for all components 1, 7 coming into contact with paint 6, no cleaning effort is required, so that a particularly rapid color change is able to be implemented, at a high process security. In addition, without extra effort, besides for the color change, the spraying part is able to be adjusted to the properties of spray fluid 6, thus, for instance, the diameter of spray opening 8 is able to be adjusted appropriately rapidly and simply.

Because of the use of atomizer air caps 12 that are customary in the trade, the same spraying quality is ensured as with so-called expert (professional) spray guns, or the like.

In an advantageous manner, as was mentioned briefly above, the one-way metering chamber or reservoir 1 can be used as mixing reactor chamber for spray fluid 6, or rather the production of the paint, which saves or avoids having to use mixing cups, or similar consumable materials, and costly handling of spray fluid 6.

1-13. (canceled)

14. A device for spraying a flowable spray fluid, comprising:
at least one fluid reservoir, including at least one partition for storing the spray fluid; and
a spray opening for the outflow of the spray fluid from the device, wherein the at least one partition of the fluid reservoir includes at least one adjustable partition region for changing a reservoir volume of the fluid reservoir.

15. The device of claim 14, wherein the reservoir region is embodied as a piston, the piston being guidable at other partition regions of the fluid reservoir.

16. The device of claim 14, further comprising:
a metering unit to meter a quantity of the spray fluid flowing out through the spray opening.

17. The device of claim 16, wherein the metering unit includes at least one drive unit for adjusting the at least one partition region.

18. The device of claim 17, wherein the at least one drive unit includes a linear drive.

19. The device of claim 17, wherein the at least one drive unit includes at least one drive spindle.

20. The device of claim 14, further comprising:
an atomizer to atomize the spray fluid.

21. The device of claim 20, wherein compressed air is an atomizer fluid.

22. The device of claim 20, wherein the atomizer is situated at least partially concentrically about the spray opening.

23. The device of claim 14, wherein the fluid reservoir includes a one-way fluid reservoir.

24. A fluid reservoir for storing a spray fluid for a device for spraying a flowable spray fluid, comprising:
a spray opening for an outflow of the spray fluid from the fluid reservoir; and
a partition of the fluid reservoir including at least one adjustable partition region for changing a reservoir volume of the fluid reservoir.

25. The fluid reservoir of claim 24, wherein the reservoir region is embodied as a piston, the piston being guidable at other partition regions of the fluid reservoir.

26. The fluid reservoir of claim 24, wherein the fluid reservoir includes a one-way fluid reservoir.
